(19) United States
(12) Patent Application Publication
(10) Pub. No.: US 2024/0054518 A1
(43) Pub. Date: Feb. 15, 2024

(54) Open system for parking of vehicles using incentives.

(71) Applicants: Nicolas Saravia, Doral, FL (US); Adolfo O. Gutierrez, CLIFTON PARK, NY (US)

(72) Inventors: Nicolas Saravia, Doral, FL (US); Adolfo O. Gutierrez, CLIFTON PARK, NY (US)

(21) Appl. No.: 17/819,734

(22) Filed: Aug. 15, 2022

(51) Int. Cl. G06Q 30/02; G06Q 20/38; G06Q 20/40; G06Q 20/36

(52) U.S. Cl. CPC G06Q 30/0215; G06Q 20/389; G06Q 20/4015; G06Q 20/3678; G06Q 2220/00; G06Q 2240/00

(57) ABSTRACT

A method for ensuring verifiable parking of micro-mobility vehicles in designated locations through centralized or decentralized systems. The invention seeks to solve situations of scattered and disorderly parking of micro-mobility vehicles. Through sensing devices, the main system receives information of a parked vehicle within a designated space, which may include vehicle features or alphanumeric code, and processes the data for verification via machine learning or other techniques. Upon verification of the proper parking of a vehicle, a ledger logs the corresponding user with the parking event. Cryptocurrency tokens may be distributed to users or operators upon verification of proper parking, depending on whether the vehicle is owned by the user or part of a shared fleet.

### CROSS REFERENCE TO RELATED APPLICATION

This application is based on provisional patent application 63/260,326 filed with the U.S. Patent and Trademark Office on Aug. 17, 2021, the entire contents of which are hereby incorporated.

### FIELD OF THE INVENTION

The present invention relates to a vehicle parking system

### BACKGROUND

Current incentives for user parking in a designated area consist of discounts for vehicle trips; however, these discounts are non-transferable and exclusive to the shared vehicle app. They are only available at predetermined locations, chosen by the shared vehicle fleet operator or by parking city managers. Micro-mobility vehicle users sometimes find other locations more convenient, resulting in scattered vehicles parked on sidewalks and other areas of pedestrian transit, which pose a major concern for city officials and residents. There are other methods for detection of micro-mobility vehicles in the market, including the use of geofencing technology, which may be subject to global positioning system errors, or sensor-driven advanced driver-assist technology, which may be used within each vehicle for parking rule enforcement; however, these methods have not implemented blockchain-enabled transactions or token incentives to promote user parking in designated areas. Furthermore, unlike current options, the present method does not require the installation of sensing devices in each vehicle, but rather places devices within or adjacent to designated parking spaces. Utilizing economic incentives, implemented using current and foreseeable technologies, to improve on the current situation by encouraging orderly parking of micro-mobility vehicles is the main objective of this invention disclosure.

### BRIEF DESCRIPTION OF THE DRAWING

FIG. 1 is a diagram illustrating the steps of the parking verification and rewards system

### SUMMARY OF THE INVENTION

A method for incentivizing proper parking by micro-mobility vehicle users and for incentivizing operators of parking locations to offer better located, well maintained and affordable solutions is described. It is such that designated micro-mobility vehicle parking locations, including but not limited to lockers, racks, and geofence areas, having a unique identifier, are equipped with sensing devices. The vehicles themselves are assumed to be equipped with a unique identifier. Both, the unique identifier for the parking locations or the unique identifier for the vehicle may be in the form of QR, alphanumeric identifiers, RFID transponders, or other forms of machine readable or detectable code. Having these identifiers makes it possible to implement several novel modalities for incentivizing both end users and parking providers using a range of solutions, from highly centralized supervisory systems, to highly decentralized market driven systems. This disclosure, without any loss of generality, describes both modalities, and provides simple conceptual implementations that are not intended to restrict the scope of the array of possible solutions we claim in this disclosure.

Centralized Architecture

The main software system receives extracted data from the sensing devices within the parking location, including vehicle type, model, or brand. Data collected is sent to a data cloud or on-premise server for data cleaning and storage. The data is then processed by the main software system, including but not limited to machine learning image recognition, which determines whether the vehicle was parked correctly in a designated location. The main software system then sends the processed data to a blockchain ledger. If the data passes the threshold for proper parking of the vehicle, a transaction is generated in the form of a blockchain token.

Once the main system determines validation via a mechanism, the token is distributed to the parking operator and to the vehicle user. In order to sustain the operation of the main system, the parking operator is discounted a fee from its token allocation for each transaction. Individual vehicle owners who park in a system-designated place, may exchange currency for tokens to reserve space and time. Shared vehicle platforms, including rental-vehicle or micro-mobility-share companies, may opt in to the system for a fee and their end-users who choose to park in a location enabled by the main system will receive an incentive token for proper use. Tokens may be accessed via mobile application using the unique identifier for the parking space or the unique identifier of the vehicle.

Decentralized Architecture

There are numerous possibilities for implementing decentralized architectures to incentivize orderly parking. One we propose is simply based on a local price auction process among a vehicle and a parking spot, where acceptance of the offer by a simple software on the parking location can encourage orderly behavior by users without the need for using either blockchains or central software tools. This mode of operation resembles that of vending machines that transact directly with the end user without using any form of central coordination. It would be best implemented using an open standard that different parking solutions vendors can easily adopt.

Types of Business Models

The system may be implemented by multiple operating entities observing the different aspects of the cycle, and in varied combinations. There may be a main system operator that maintains the sensing units and unique identifiers, in addition to the ledger and verified transaction flows, a separate operator that provides and oversees the parking infrastructure and space, and a third operator (or set of operators) of shared or rental mobility. Another business model implementation option could be a single operator for the main system, including sensing devices and the parking infrastructure, working with separate mobility operators. A third option could be a single entity, operating the transaction flows and main system, mobility, and parking infrastructure operations. Whether the vehicle user receives tokens for parking or pays fees for reserving space may vary on the different models described, and on the type of vehicle used (operator-owned versus privately-owned).

### DETAILED DESCRIPTION

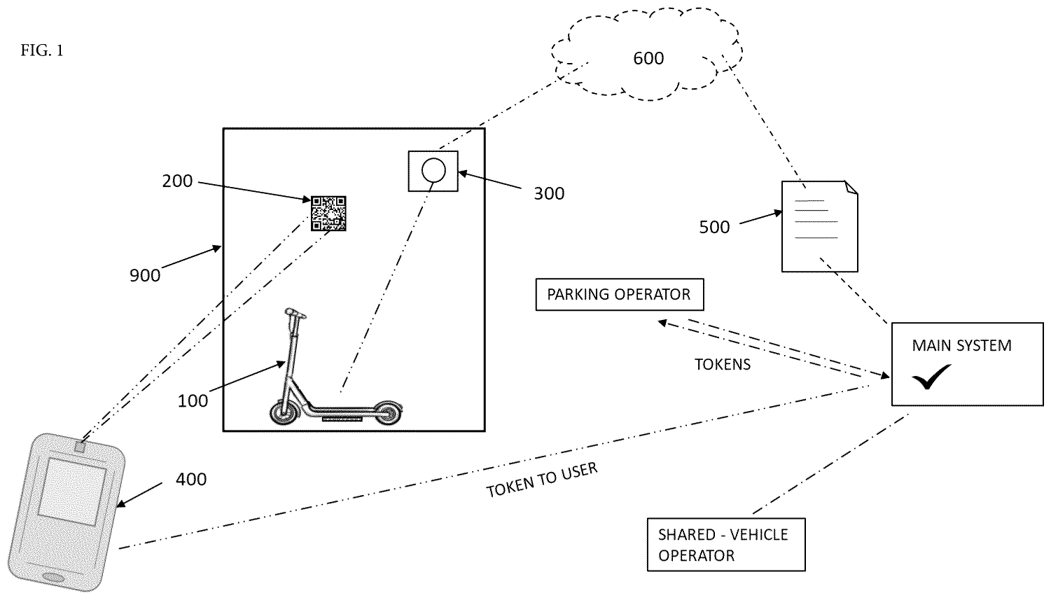

Referring to the drawing, where a physical space, enclosed or otherwise, defined by physical or digital features is used for parking or storage of vehicles. Though FIG. 1. shows 900 an enclosed locker, the system may be used in any space for purposes of proper parking or storage of 100 vehicles, such as but not limited to, bicycle racks, traditional curbside delineated spaces, or geofence areas.

Each parking space includes a visible 200 unique identifier, such as but not limited to, a QR code or alphanumeric series. Each parking space or set of spaces is also equipped with a 300 sensing device, which may be but not limited to, motion detectors, proximity sensors, cameras, or beacons. The 300 sensing device communicates the presence of a transportation 100 vehicle and extracts feature information upon its detection of a 100 vehicle in a designated space. The information may be and is not limited to images or descriptive text of the vehicle(s) and the space. The 300 sensor may also communicate a request for information from the user's 400 mobile device or other external sensing devices, including those located within the vehicles or the parking space(s). The information requested may include battery levels and other environmental or vehicular data, such as time of parking space occupancy or vehicle part health metrics. The data sent to a server by the 300 sensors, is sent to a main system, consisting of software and/or database components, where it may be cleaned or processed via a 600 cloud or remote program. For the purposes of this invention, processing may include but is not limited to, programmable actions for quality checks or alarm settings.

Once the user scans or inputs the 200 unique identifier of the space onto a mobile application or authenticator, the data is then stored in a blockchain ledger, which may be centralized or decentralized. The incoming data is then subject to a validation mechanism and stored in a 500 ledger upon verification of the user scan. If the data

We claim:

1. A method for parking management for a plurality of micro-mobility devices that consists of,
a. sub system for physically organizing the vehicles, and
b. A sub system for monitoring the acceptance, presence and removal of said vehicles, and
c. A sub system for coordinating operation at one location and at multiple locations within a service area that uses blockchain enabled transactions for payments, verification, authentication and access control.

1.1. The method of #1 in which the sub system for physically organizing the vehicles can include any of the following methods,
a. Open parking spaces in an open area of a sidewalk or street, or
b. Closed parking spaces in a controlled premise, such as lockers or racks or privately operated parking areas.

2.1. The method of #1 in which the sub system for monitoring the acceptance, presence and removal of said vehicles is based on distance or stand-off sensing such as those comprising any of the following
a. A sensing system that uses optical bar codes, or
b. A sensing system that uses RFID tags,
c. A sensing system that uses optical vision,
d. A sensing system that uses QR codes,
e. A sensing system that uses alphanumeric codes

2.2. The methods of #2.1 are used to identify and measure reference points including those describing, without any loss of generality, for instance
a. Features of the vehicle
b. Features of the parking space
c. Unique identifiers for each parking space

2.3. A method for doing #1 using a computing system that remotely oversees the devices, consisting of
a. Means for processing and collecting data from sensors, or
b. Means for processing and collecting data from vehicles
c. Means for detecting anomalies in vehicle features
d. Means for detecting parking area features
e. Means for detecting temperature and humidity of the vehicle or parking area
f. Means for detecting time of occupancy of the parking space
g. Means for detecting battery level of the vehicle within the parking space

3. A method for processing data from #2 into incentive for vehicle parking, which may include:
a. Storage of vehicle and parking data collected in a blockchain ledger
b. Means for delivery of the blockchain token for parking incentive to a mobile application
c. Means for configuration of said token and data to display on a mobile application or cryptocurrency wallet
